(19) United States
(12) Patent Application Publication
(10) Pub. No.: US 2003/0043801 A1
(43) Pub. Date: Mar. 6, 2003

(54) Packet display, packet data creating device and method, and recorded medium

(76) Inventor: Tokio Seko, Gunma-ken (JP)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/181,979

(22) PCT Filed: Jan. 30, 2001
(86) PCT No.: PCT/JP01/00608

(30) Foreign Application Priority Data
Feb. 4, 2000 (JP) 2000-027016

(51) Int. Cl. H04L 12/28

(52) U.S. Cl. 370/389; 370/465

(57) ABSTRACT

To easily comprehend the test contents by searching a packet from a vector-pattern (logic pattern).

The packet is searched automatically from an inner of a logic pattern and displayed by a packet display. The packet display includes: a packet detection unit 10 for detecting an existence display character pattern showing the existence of the packet; a packet start position calculation unit 12 for calculating a start position of the packet located at predetermined distance from said existence display character pattern; a packet data fetch unit 14 for fetching the packet data having predetermined length from the start position of the packet; a packet type determination unit 16 for determining the type of packet based on the fetched packet data; a packet information calculation unit 17 for calculating packet information corresponding to the type of packet from the packet type and the packet data; and a packet display unit 18 for displaying said packet type and said packet information.

### TECHNICAL FIELD

The present invention relates to a skill that extracts a packet (data defining an operation of device under test) from a vector-pattern (logic pattern) to be inputted to Device Under Test (DUT), and converts the extracted packet into the vector-pattern (logic pattern) to be inputted to device under test.

### BACKGROUND ART

There is a test applying the vector-pattern (logic pattern) consisting of character string such as “0, 1, H, L, X” to devices such as Rambus (US Rambus Inc.) spec DRAM or synclink DRAM (SLDRAM). The size of the vector-pattern comprises up to tens of thousands—several millions steps. FIG. 12 shows a sample of the vector-pattern (logic pattern). In sample shown in FIG. 12, the longitudinal direction indicates the number of steps (size) of pattern and the transverse direction indicates coordinates onto a device-pin.

Such vector-pattern is needed about 10-20 pieces per one device product, and one file size becomes several mega byte. Total capacity of the vector-pattern (logic pattern) becomes sufficiently 200 mega byte.

Inner of vector-pattern (logic pattern) applied to devices such as Rambus DRAM stores command, so called a packet defining the operation of device. The packet comprises predetermined characters, for example “0, 1”. Furthermore, as shown in FIG. 12, the packet includes combination of character matrix, for example combination of row data “001”, “101”, “101” in succession.

It is effective to find out what kind of test is to be performed to the device by a device test according to the vector-pattern. At this point, it is possible to know what kind of test is performed, by reading out the vector-pattern that has total capacity of sufficiently 200 mega byte and searching the packet. It is also possible to prepare test-pattern independently using the searched packet.

However, as apparent from sample shown in FIG. 12, it is difficult to search the packet from the vector-pattern (logic pattern). It is also difficult to search the packet since the total capacity of the vector-pattern is very large. Although the packet is searched, it is cumbersome to prepare the test-pattern using such packet.

Therefore, the object of the present invention is to provide a skill wherein packet is searched from vector-pattern (logic pattern) to easily comprehend the test contents and the test-pattern is prepared independently using such packet.

### DISCLOSURE OF INVENTION

According to the present invention as described in claim 1, a packet display which extracts packet from logic pattern having the packet and displays, the packet consisting of predetermined characters and defining an operation of a device, includes: a packet detection unit for detecting an existence display character pattern showing the existence of the packet; a packet start position calculation unit for calculating a start position of the packet located at a predetermined distance from the existence display character pattern; a packet data fetch unit for fetching a packet data having a predetermined length from the start position of the packet; a packet type determination unit for determining the type of packet based on the fetched packet data; a packet information calculation unit for calculating a packet information corresponding to the type of packet from the packet type and the packet data; and a packet display unit for displaying the packet type and the packet information.

According to the packet display constituted as above, the packet is automatically searched and displayed from the inner of the logic pattern.

According to the present invention as described in claim 2, a packet display which extracts packet from logic pattern having the packet and displays, the packet consisting of predetermined characters and defining an operation of a device, includes: a packet detection unit for detecting an existence display character pattern showing the existence of the packet; a packet data fetch unit for fetching a packet data having a predetermined length from the existence display character pattern; a packet type determination unit for determining the type of packet based on the fetched packet data; a packet information calculation unit for calculating a packet information corresponding to the type of packet from the packet type and the packet data; and a packet display unit for displaying the packet type and the packet information.

According to the present invention as described in claim 3, a packet display which extracts packet from logic pattern having the packet and displays, the packet consisting of predetermined characters and defining an operation of device, includes: a packet start position calculation unit for calculating a start position of the packet; a packet data fetch unit for fetching a packet data having a predetermined length from the start position of the packet; a packet information calculation unit for calculating a packet information corresponding to the type of packet from the packet data; and a packet display unit for displaying the packet type and the packet information.

According to the present invention as described in claim 4, a packet data generator which generates packet data from packet pattern having a packet type defining an operation of a device and a packet information corresponding to the packet type, the packet data being applied to the device, includes: a packet type acquisition unit for acquiring the type of the packet from the packet pattern; and a packet data calculation unit for calculating a packet data from the packet information based on the packet type.

According to packet data generator constituted as above, the packet data are automatically calculated from the packet pattern.

The present invention as described in claim 5, is a packet data generator according to claim 4, wherein the packet pattern can be edited.

Here, the edition means to add, delete or change the packet pattern. The optional packet data are generated by means of editing the packet pattern.

The present invention as described in claim 6, is a packet data generator according to claim 5, wherein a packet pattern implying a repeating operation can be added to the packet pattern.

The present invention as described in claim 7, is a packet data generator according to claim 5, wherein a packet pattern implying an addition or a subtraction of the packet information by a predetermined amount can be added to the packet pattern.

The present invention as described in claim 8, is a packet data generator according to claim 4, wherein the packet pattern, which includes predetermined character, is displayed from logic pattern having packet defining an operation of device by a packet display according to any one of claims 1-3.

The packet display as described in any one of claims 1 to 3 displays the packet pattern, so that it is capable of generating packet data based on display result of the packet display.

The present invention as described in claim 9, is a packet data generator according to claim 8, wherein the packet pattern can be edited.

Here, the edition means to add, delete or change the packet pattern. The optional packet data are generated by means of editing the packet pattern.

The present invention as described in claim 10, is a packet data generator according to claim 9, wherein a packet pattern that does not exist in the logic pattern can be added to the packet pattern.

Range of available packet pattern can be expanded by addition of the packet pattern that does not exist in the logic pattern.

The present invention as described in claim 11, is a packet display according to any one of claims 1 to 3, wherein the packet display unit displays the existence position of the packet in the logic pattern.

According to the present invention as described in claim 12, a packet display method for extracting packet from logic pattern having the packet and displays, the packet consisting of predetermined characters and defining an operation of a device, includes: a packet detection step for detecting an existence display character pattern showing the existence of the packet; a packet start position calculation step for calculating a start position of the packet located at a predetermined distance from the existence display character pattern; a packet data fetch step for fetching a packet data having a predetermined length from the start position of the packet; a packet type determination step for determining the type of packet based on the fetched packet data; a packet information calculation step for calculating a packet information corresponding to the type of packet from the packet type and the packet data; and a packet display step for displaying the packet type and the packet information.

According to the present invention as described in claim 13, a packet display method for extracting packet from logic pattern having the packet and displays, the packet consisting of predetermined characters and defining an operation of a device, includes: a packet detection step for detecting an existence display character pattern showing the existence of the packet; a packet data fetch step for fetching a packet data having a predetermined length from the existence display character pattern; a packet type determination step for determining the type of packet based on the fetched packet data; a packet information calculation step for calculating a packet information corresponding to the type of packet from the packet type and the packet data; and a packet display step for displaying the packet type and the packet information.

According to the present invention as described in claim 14, a packet display method for extracting packet from logic pattern having the packet and displays, the packet consisting of predetermined characters and defining an operation of device, includes: a packet start position calculation step for calculating a start position of the packet; a packet data fetch step for fetching a packet data having a predetermined length from the start position of the packet; a packet information calculation step for calculating a packet information corresponding to the type of packet from the packet data; and a packet display step for displaying the packet type and the packet information.

According to the present invention as described in claim 15, a packet data generation method for generating packet data from packet pattern having a packet type defining an operation of a device and a packet information corresponding to the packet type, the packet data being applied to the device, includes: a packet type acquisition step for acquiring the type of the packet from the packet pattern; and a packet data calculation step for calculating a packet data from the packet information based on the packet type.

According to the present invention as described in claim 16, a computer-readable medium having a program of instructions for execution by the computer to perform a packet display processing for extracting packet from logic pattern having the packet and displays, the packet consisting of predetermined characters and defining an operation of a device, the packet display processing includes: a packet detection processing for detecting an existence display character pattern showing the existence of the packet; a packet start position calculation processing for calculating a start position of the packet located at a predetermined distance from the existence display character pattern; a packet data fetch processing for fetching a packet data having a predetermined length from the start position of the packet; a packet type determination processing for determining the type of packet based on the fetched packet data; a packet information calculation processing for calculating a packet information corresponding to the type of packet from the packet type and the packet data; and a packet display processing for displaying the packet type and the packet information.

According to the present invention as described in claim 17, a computer-readable medium having a program of instructions for execution by the computer to perform a packet display processing for extracting packet from logic pattern having the packet and displays, the packet consisting of predetermined characters and defining an operation of a device, the packet display processing includes: a packet detection processing for detecting an existence display character pattern showing the existence of the packet; a packet data fetch processing for fetching a packet data having a predetermined length from the existence display character pattern; a packet type determination processing for determining the type of packet based on the fetched packet data; a packet information calculation processing for calculating a packet information corresponding to the type of packet from the packet type and the packet data; and a packet display processing for displaying the packet type and the packet information.

According to the present invention as described in claim 18, a computer-readable medium having a program of instructions for execution by the computer to perform a packet display processing for extracting packet from logic pattern having the packet and displays, the packet consisting of predetermined characters and defining an operation of device, the packet display processing includes: a packet start position calculation processing for calculating a start position of the packet; a packet data fetch processing for fetching a packet data having a predetermined length from the start position of the packet; a packet information calculation processing for calculating a packet information corresponding to the type of packet from the packet data; and a packet display processing for displaying the packet type and the packet information.

According to the present invention as described in claim 19, a computer-readable medium having a program of instructions for execution by the computer to perform a packet data generation processing for generating packet data from packet pattern having a packet type defining an operation of a device and a packet information corresponding to the packet type, the packet data being applied to the device, the packet data generation processing includes: a packet type acquisition processing for acquiring the type of the packet from the packet pattern; and a packet data calculation processing for calculating a packet data from the packet information based on the packet type.

According to the present invention as described in claim 20, a packet display which extracts packet from logic pattern having the packet and displays, the packet consisting of predetermined characters and defining an operation of a device, includes: a packet detection unit for detecting an existence display character pattern showing the existence of said packet; and a packet display unit for displaying said packet corresponding to the detected existence display character pattern.

According to the present invention as described in claim 21, a packet display method for extracting packet from logic pattern having the packet and displays, the packet consisting of predetermined characters and defining an operation of a device, includes: a packet detection step for detecting an existence display character pattern showing the existence of said packet; and a packet display step for displaying said packet corresponding to the detected existence display character pattern.

According to the present invention as described in claim 22, a computer-readable medium having a program of instructions for execution by the computer to perform a packet display processing for extracting packet from logic pattern having the packet and displays, the packet consisting of predetermined characters and defining an operation of a device, said packet display processing includes: a packet detection processing for detecting an existence display character pattern showing the existence of said packet; and a packet display processing for displaying said packet corresponding to the detected existence display character pattern.

### BRIEF DESCRIPTION OF THE DRAWINGS

FIG. 1 is a block diagram of a packet display and a packet data generator according to the first embodiment of the invention.

FIG. 2 shows an example of the packet data generator existed solely.

FIG. 3 shows examples of a logic pattern (FIG. 3(a)) and a packet pattern (FIG. 3(b)).

FIG. 4 shows a display example of the packet pattern.

FIG. 5 shows a result of edition of the packet pattern shown in FIG. 4.

FIG. 6 shows a result that the packet data calculation unit 22 has calculated the packet data.

FIG. 7 is a flow chart showing the operation of the first embodiment.

FIG. 8 is a block diagram of the packet display and the packet data generator according to the second embodiment of the invention.

FIG. 9 shows an example of the packet data.

FIG. 10 is a block diagram of the packet display and the packet data generator according to the third embodiment of the invention.

FIG. 11 shows an example of the packet data.

FIG. 12 shows an example of prior art logic pattern.

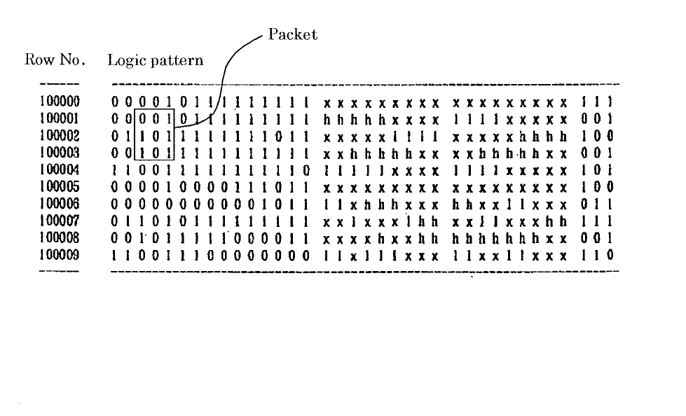

### BEST MODE FOR CARRYING OUT THE INVENTION

The preferred embodiments of the invention are described below with reference to accompanying drawings.

First Embodiment

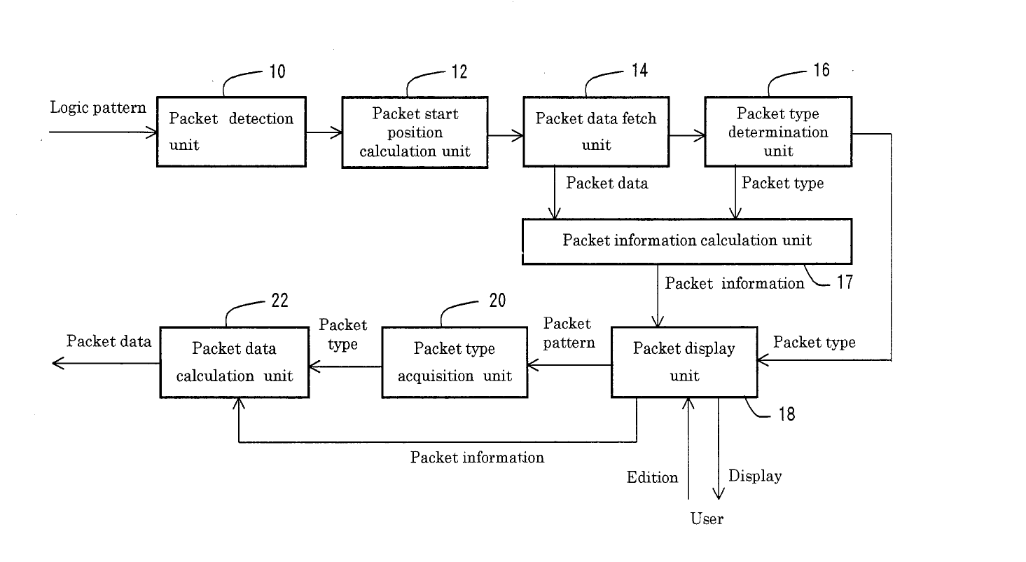

FIG. 1 is a block diagram of the packet display and the packet data generator according to the first embodiment of the invention

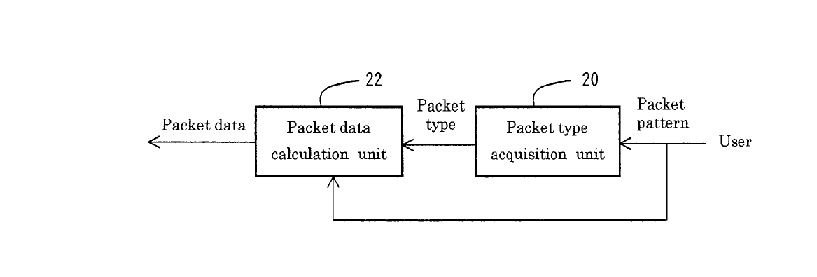

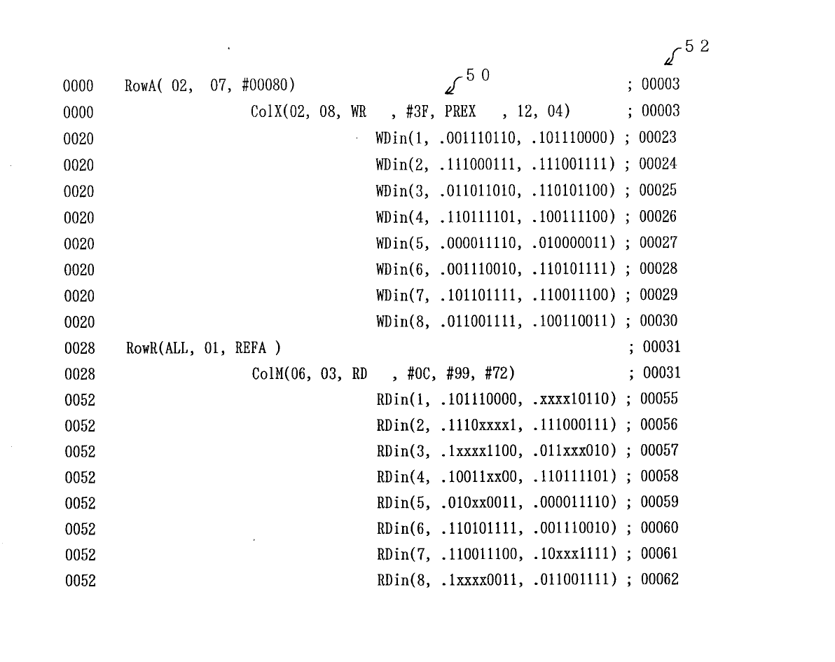

The packet display comprises a packet detection unit 10, a packet start position calculation unit 12, a packet data fetch unit 14, a packet type determination unit 16, a packet information calculation unit 17, and a packet display unit 18. The packet data generator comprises a packet type acquisition unit 20 and a packet data calculation unit 22. The packet data generator may be constituted solely as shown in FIG. 2, without the packet display. In case that the packet data generator exists solely, a user prepares packet pattern (see FIG. 4) using any method to apply the pattern to the packet data generator.

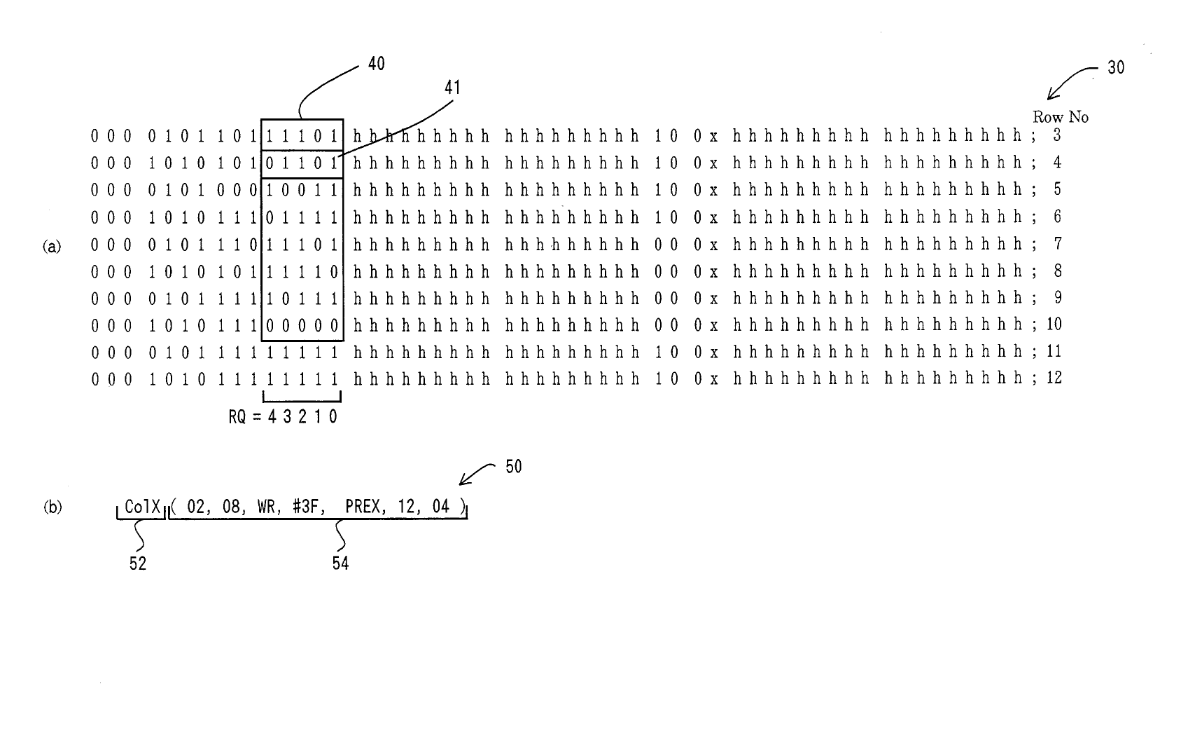

FIG. 3(a) shows one example of the logic pattern. The logic pattern 30 shown in FIG. 3(a) comprises packet data such as “0, 1, h, l, x”. The characters ;3, ;4, . . . ;12 on right end are row numbers attached for the convenience of description, and do not constitute a portion of the logic pattern. The logic pattern is a test pattern to be applied to devices such as Rambus (US Rambus Inc.) spec DRAM or synclink DRAM (SLDRAM).

A packet 40 exists in logic pattern 30. The packet means a data group defining an operation of a device. The packet has a type, and Rambus (US Rambus Inc.) spec DRAM has the types such as RowA, RowR, ColM, ColX, RDIN, WDIN.

The packet 40 has an existence display character pattern 41 displaying the existence of the pattern. The packet 40 does not necessarily start from the existence display character pattern 41. The packet 40 starts from character string “11101” of row 3. The start position of the packet 40 is apart from the existence display character pattern 41 by a predetermined distance.

One example of the packet pattern is shown in FIG. 3(b). The packet 40 is converted into packet pattern 50 shown in FIG. 3(b) by mean of method to be mentioned later. The packet type 52 is a type of the packet (“ColX” in example of FIG. 3(b)), and the packet information 54 is the peculiar information of the packet according to the packet type.

Referring back to FIG. 1, the packet detection unit 10 detects the packet 40 from the logic pattern 30 by detecting the existence display character pattern 41. The packet start position calculation unit 12 calculates the start position of packet 40 located at a predetermined distance from the existence display character pattern 41. In example of FIG. 3(a), the start position is row one before from row 4 existing in the existence display character pattern 41. The packet data fetch unit 14 fetches a packet data having a predetermined length from the start position of packet 40. In example of FIG. 3(a), it fetches the data by 8 rows from row 3 of the start position, i.e. row 3 to row 10. The packet type determination unit 16 determines the packet type 52 from packet data. In example of FIG. 3(a), it is determined to be ColX by a determination method mentioned later. The packet information calculation unit 17 calculates packet information 54 from the packet type and the packet data by a determination method mentioned later. The packet display unit 18 combines the packet type and the packet information to display the packet pattern 50.

A plurality of packets exists in the logic pattern 30 in general, and a packet pattern corresponding thereto being displayed by packet display unit 18 to be a display contents as shown in FIG. 4. At that time, the packet display unit 18 displays row number 52 having the packet in the logic pattern 30. For example, the packet pattern 50 is located at row 3 in FIG. 3(a), and displayed as “0003” on right end of the display contents of the packet display unit 18 shown in FIG. 4.

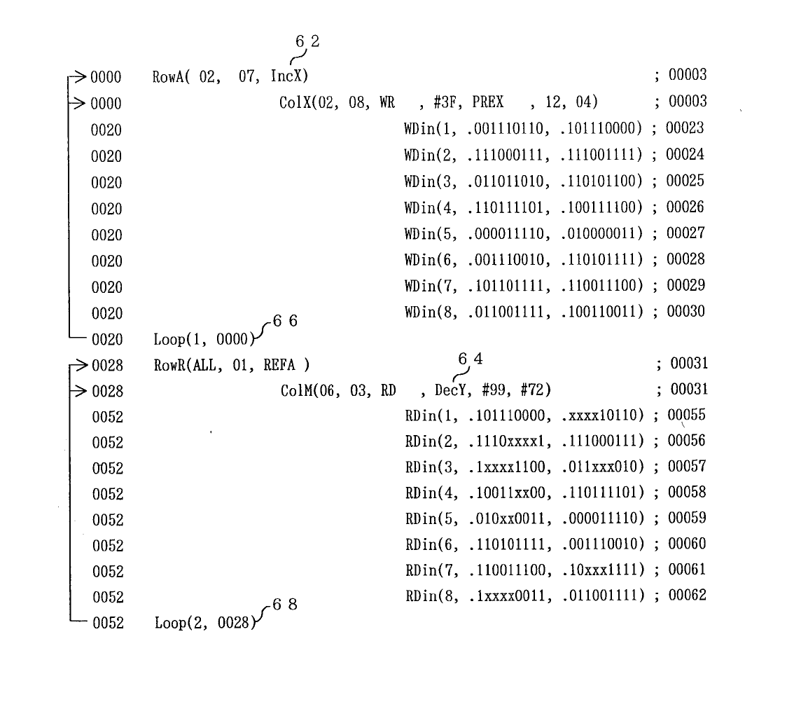

The user can edit the packet pattern as shown in FIG. 4. That is, the user is capable of adding, deleting and changing the packet pattern. FIG. 5 shows the result of edition of the packet pattern shown in FIG. 4. An increment packet 62 is added to a packet RowA, and a decrement packet 64 is added to packet ColM. Newly, loop packets 66, 68 are also added. The increment packet, the decrement packet and the loop packets are new packets that do not exist in the logic pattern 30. Such addition of new packets is possible.

The increment packet means an increment that increases an argument by certain amounts. The decrement packet means a decrement that decreases an argument by certain amounts. In the loop packets of both types, a left argument illustrates the number of repeat operation and a right argument illustrates a branch address on left end. For example, the loop packet 66 means to branch into first loop, 0000, and the loop packet 68 means to branch into second loop 0028.

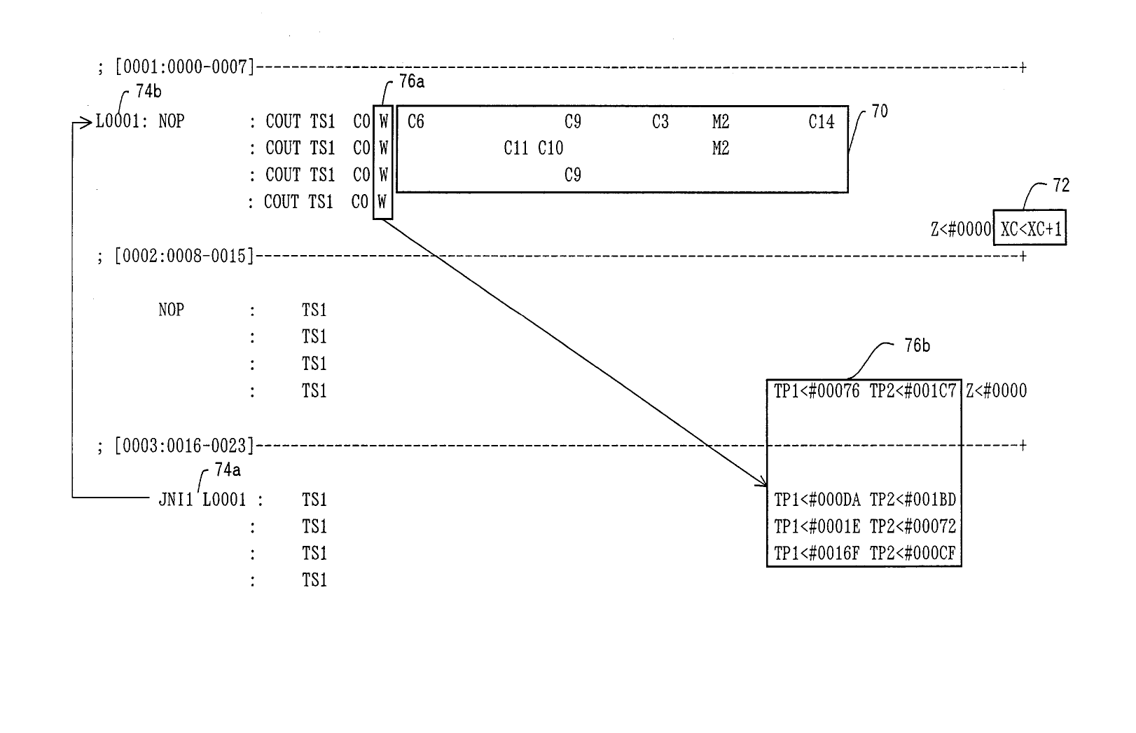

The packet type acquisition unit 20 acquires the packet type from the packet pattern edited as above. The packet data calculation unit 22 calculates the packet data from the packet type acquired by the packet type acquisition unit 20 and the packet data. FIG. 6 shows a result of calculation of the packet data. In case of calculating packet data, one may change the arrangement of data suitably without returning to original logic pattern. For instance, the packet data of which type is corresponding to ColX of the packet pattern 50 is a packet data 70, and the packet data corresponding to the loop packet 66 is a packet data 74a, b. The packet data corresponding to the decrement packet 64 is a packet data 72. The packet data corresponding to the increment packet 62 not shown in FIG. 6 for the convenience of representation will be represented (YC<YC−1) similar to the decrement packet 64.

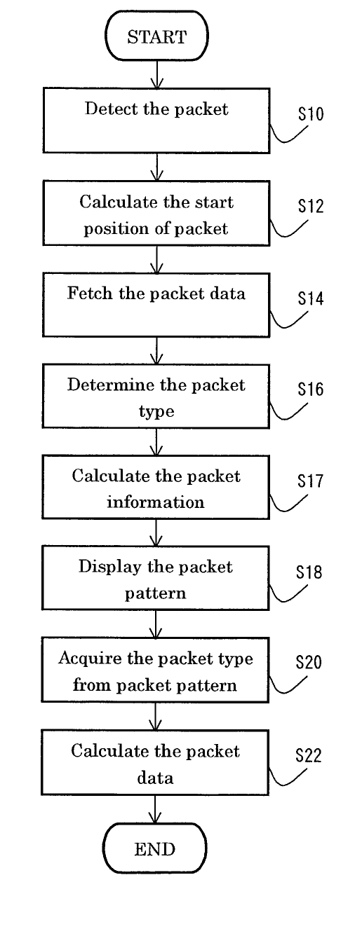

Next, operation of the first embodiment will be explained with reference to flow chart of FIG. 7.

At first, the packet detection unit 10 detects the packet (S10). Following description is based on example of FIG. 3(a). The existence display character pattern 41 of which type is Col, namely any one of ColX, ColM is “0” on left end. Then, data at row 4 is “0” on left end. Accordingly, the packet of type Col is detected.

Next, the packet start position calculation unit 12 calculates start potion (S12). In case of packet having type Col, the position going back 1 row from the existence display character pattern 41 becomes a start position. Thus, the start position of row 3 is calculated.

Subsequently, the packet data fetch unit 14 fetches packet data by a predetermined length (S14). In case of packet having type Col, the length of the packet is determined to be 8 rows, and packet data from row 3 to row 10 are read out.

Next, the packet type determination unit 16 determines type of packet (S18). Then, the calculation is performed by means of reversing the packet data (0→1, 1→0) because the device is a negative logic. As shown in Table 1, if the type is ColX, row 4 of RQ3 becomes 0 after inversion. Here, since row 4 of RQ3 is “1” and becomes “0” after inversion, the packet type is determined to be ColX.

TABLE 1

| | Row 3 | Row 4 | Row 5 | Row 6 | Row 7 | Row 8 | Row 9 | Row 10 |
|---|---|---|---|---|---|---|---|---|
| RQ4 | DC4 | S = 1 | DX4 | XOP4 | RsvB | BX1 | RsvC | C4 |
| RQ3 | DC3 | M = 0 | DX3 | XOP3 | RsvB | BX0 | C5 | C3 |
| RQ2 | DC2 | COP1 | DX2 | XOP2 | BX3 | RsvB | BC2 | C2 |
| RQ1 | DC1 | COP0 | DX1 | XOP1 | BX2 | RsvB | BC1 | C1 |
| RQ0 | DC0 | COP2 | DX0 | XOP0 | COP3 | BC3 | BC0 | C0 |

Next, the packet information calculation unit 17 calculates the packet information (S17). ColX has device ID, bank, Y address as the packet information. The device ID is DC4 DC3 DC2 DC1 DC0 (binary system), bank being BC3 BC2 BC1 BC0 (binary system), Y address being C5 C4 C3 C2 C1 C0 (binary system). Since device is negative logic, inversion of packet data creates device ID 00010 (binary system)=02 (decimal system), bank 1000 (binary system)=08 (decimal system), Y address 111111 (binary system)=3F (hexadecimal system).

The ColX further has a command as the packet information. The command is found to be WR in Table 2.

TABLE 2

| COP | 3 | 2 | 1 | 0 | Command | Function |
|---|---|---|---|---|---|---|
| | x | 0 | 0 | 0 | NOCOP | No operation |
| | x | 0 | 0 | 1 | WR | Write column |
| | x | 0 | 1 | 0 | RSRV | Reserved, no operation |
| | x | 0 | 1 | 1 | RD | Read column |
| | x | 1 | 0 | 0 | PREC | Precharge bank |
| | x | 1 | 0 | 1 | WRA | Precharge bank after write |
| | x | 1 | 1 | 0 | RSRV | Reserved, no operation |
| | x | 1 | 1 | 1 | RDA | Precharge bank after read |
| | 1 | x | x | x | RLXC | Standby power state |

The ColX further has an expansion command, and device ID and bank regarding the expansion command as the packet information. The device ID regarding the expansion command is DX4 DX3 DX2 DX1 DX0 (binary system), bank being BX3 BX2 BX1 BX0 (binary system). Thus, device ID regarding the expansion command is 01100 (binary system)=12 (decimal system), bank being 0100 (binary system)=4 (decimal system). The expansion command is found to be PREX in Table 3.

TABLE 3

| XOP | 4 | 3 | 2 | 1 | 0 | Command | Function |
|---|---|---|---|---|---|---|---|
| | 0 | 0 | 0 | 0 | 0 | NOXOP | No operation |
| | 1 | x | x | x | 0 | PREX | Precharge bank |
| | x | 1 | 0 | x | 0 | CAL | Calibrate |
| | x | 1 | 1 | x | 0 | CAL/SAM | Calibrate and Sample |
| | x | x | x | 1 | 0 | RLXX | Standby power state |

Finally, it becomes a type such as the packet information 54 (see FIG. 3(b)). Then, the packet display unit 18 displays the packet type and the packet information in pair (S18). Namely, the packet pattern is displayed as the type of the packet pattern 50 (see FIG. 3(b)). Here, since a plurality of packet exist in the inner of the logic pattern 30, it is displayed as illustrated in FIG. 4 and edited by the user as illustrated in FIG. 5. In FIG. 5 as explained above, new packets, i.e. the increment packet, the decrement packet and the loop packet not existing in the logic pattern 30 are added.

Then, the packet type acquisition unit 20 acquires the packet type from each packet pattern (S20). And, the packet data calculation unit 20 calculates the packet data on the basis of the packet type and the packet information (S22). In case of packet type ColX, since data are calculated from the packet information as shown Table 4(a), the data are converted into the type of Table 4(b) and substituted for packet data 70 of FIG. 6. As such, the packet data are calculated and converted into a desired type.

TABLE 4
(a)

| | | | | | | | |
|---|---|---|---|---|---|---|---|
| DC4 | S = 1 | DX4 | XOP4 | RsvB | BX1 | RsvC | C4 |
| DC3 | M = 0 | DX3 | XOP3 | RsvB | BX0 | C5 | C3 |
| DC2 | COP1 | DX2 | XOP2 | BX3 | RsvB | BC2 | C2 |
| DC1 | COP0 | DX1 | XOP1 | BX2 | RsvB | BC1 | C1 |
| DC0 | COP2 | DX0 | XOP0 | COP3 | BC3 | BC0 | C0 |

↓
(b)

| | | | | | | | |
|---|---|---|---|---|---|---|---|
| C12 | M2 | C12 | M2 | C12 | M2 | FL | Y7 |
| C11 | M1 | C11 | M1 | C11 | M1 | Y8 | Y6 |
| C10 | C15 | C10 | C15 | C10 | FL | Z6 | Y5 |
| C9 | C14 | C9 | C14 | C9 | FL | Z5 | Y4 |
| C8 | C13 | C8 | C13 | C8 | Z7 | Z4 | Y3 |

Second Embodiment

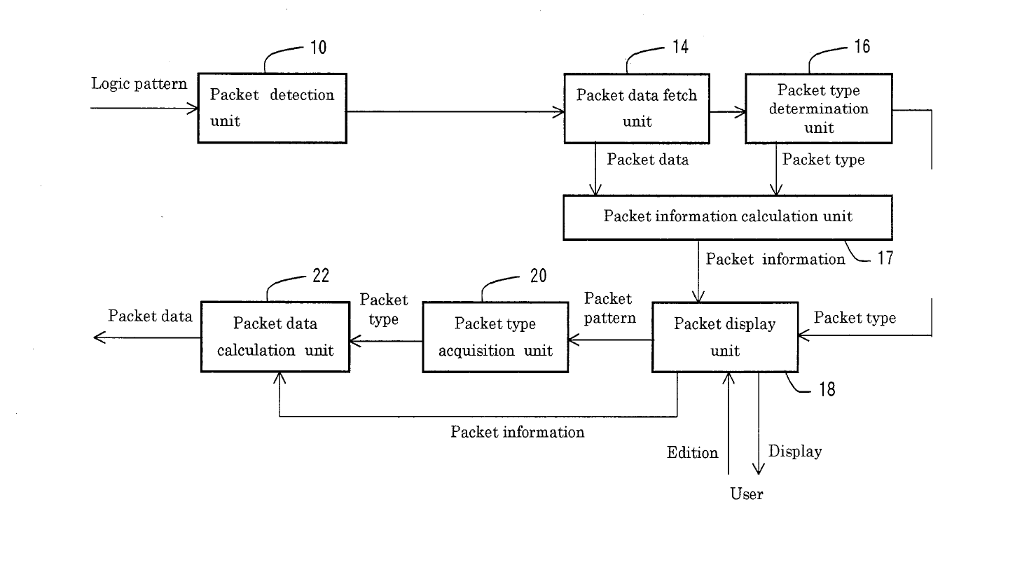

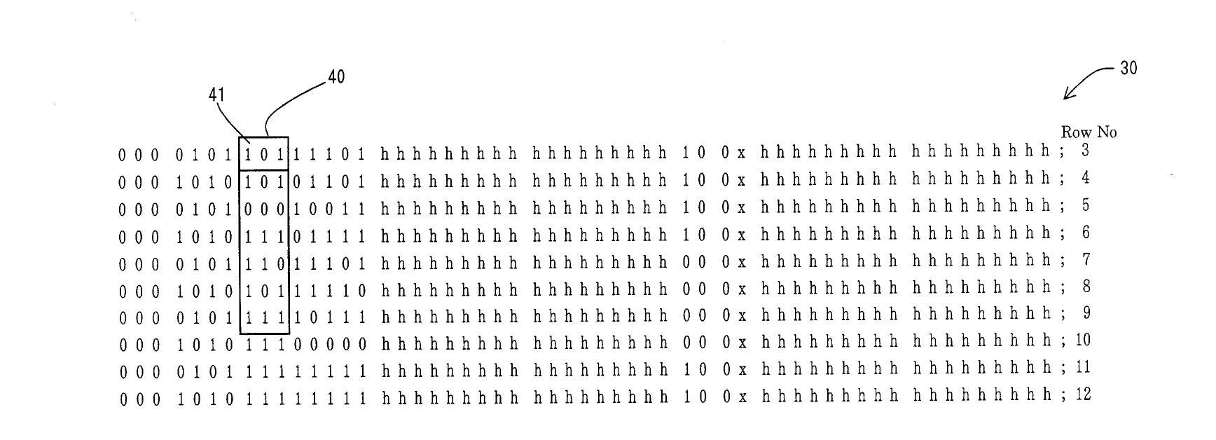

The second embodiment differs from the first embodiment in that the packet display has not the packet start position calculation unit 12 as shown in FIG. 8. Namely, in case that the packet 40 starts from the existence display character pattern 41, it is not necessary to calculate packet start position. In case of RowA packet, for instance, since the packet 40 starts from the existence display character pattern 41 as shown in FIG. 9 and need not calculate the packet start position, it is not necessary to comprise the packet start position calculation unit 12.

Third Embodiment

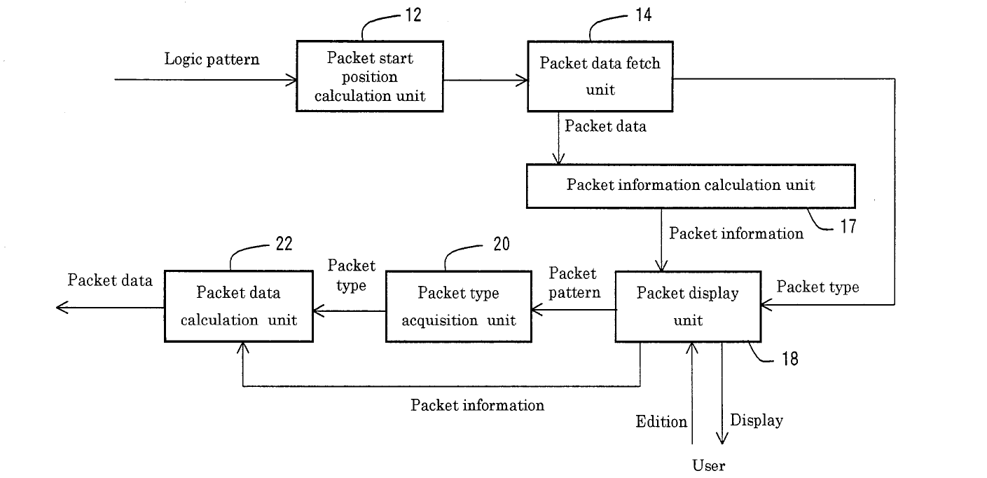

The third embodiment differs from the first embodiment in that the packet display has not the packet detection unit 10 and packet type determination unit 16 as shown in FIG. 10. Namely, packet 40 is positioned apart from other packet by a predetermined distance, and the type is decided uniformly. If position of other packet is found, start position can be calculated without detecting the existence of packet 40, so that the packet detection unit 10 is not necessary. Furthermore, the type of packet 40 is decided uniformly, and thus it is not necessary to determine the packet type.

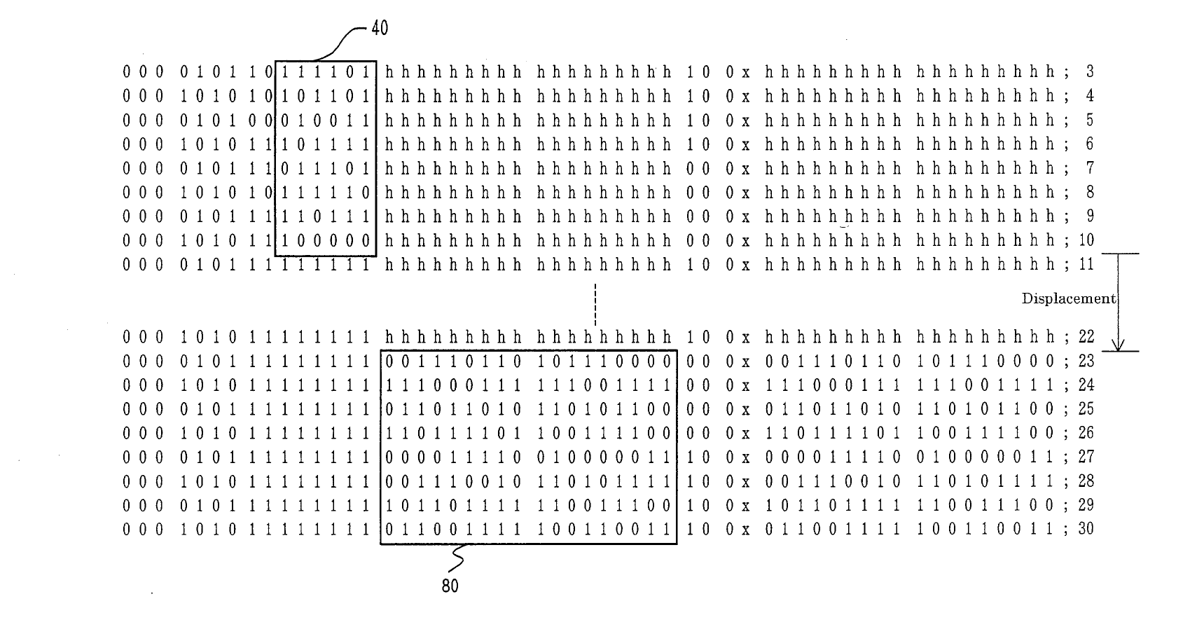

In case of WDIN packet, for example, it is apart from packet pattern 40 of type ColX by a predetermined distance (for example, row 23−row 10=13 rows) as shown in FIG. 11. Thus, the position of packet pattern 40 of type ColX is found, so that the position of WDIN packet pattern 80 is calculated by means of packet start position calculation unit 12. The WDIN packet pattern following the type ColX packet pattern is determined uniformly, and thus packet type determination unit 16 is unnecessary.

Additionally, the packet data corresponding to the WDIN packet becomes the packet data 76a,b (see FIG. 6).

Industrial Applicability

According to the present invention, the packet is automatically searched from the logic pattern and displayed. Furthermore, the packet data are automatically calculated from the packet pattern.

1. A packet display which extracts packet from logic pattern having the packet and displays, the packet consisting of predetermined characters and defining an operation of a device, comprising:
a packet detection unit for detecting an existence display character pattern showing the existence of said packet;
a packet start position calculation unit for calculating a start position of said packet located at a predetermined distance from said existence display character pattern;
a packet data fetch unit for fetching a packet data having a predetermined length from the start position of said packet;
a packet type determination unit for determining the type of packet based on the fetched packet data;
a packet information calculation unit for calculating a packet information corresponding to said type of packet from said packet type and said packet data; and
a packet display unit for displaying said packet type and said packet information.

2. A packet display which extracts packet from logic pattern having the packet and displays, the packet consisting of predetermined characters and defining an operation of a device, comprising:
a packet detection unit for detecting an existence display character pattern showing the existence of said packet;
a packet data fetch unit for fetching a packet data having a predetermined length from said existence display character pattern;
a packet type determination unit for determining the type of packet based on the fetched packet data;
a packet information calculation unit for calculating a packet information corresponding to said type of packet from said packet type and said packet data; and
a packet display unit for displaying said packet type and said packet information.

3. A packet display which extracts packet from logic pattern having the packet and displays, the packet consisting of predetermined characters and defining an operation of device, comprising:
a packet start position calculation unit for calculating a start position of said packet;
a packet data fetch unit for fetching a packet data having a predetermined length from the start position of said packet;
a packet information calculation unit for calculating a packet information corresponding to said type of packet from said packet data; and
a packet display unit for displaying said packet type and said packet information.

4. A packet data generator which generates packet data from packet pattern having a packet type defining an operation of a device and a packet information corresponding to said packet type, said packet data being applied to said device, comprising:
a packet type acquisition unit for acquiring the type of said packet from said packet pattern; and
a packet data calculation unit for calculating a packet data from said packet information based on said packet type.

5. A packet data generator according to claim 4, wherein said packet pattern can be edited.

6. A packet data generator according to claim 5, wherein a packet pattern implying a repeating operation can be added to said packet pattern.

7. A packet data generator according to claim 5, wherein a packet pattern implying an addition or a subtraction of said packet information by a predetermined amount can be added to said packet pattern.

8. A packet data generator according to claim 4, wherein said packet pattern, which comprises predetermined character, is displayed from logic pattern having packet defining an operation of device by a packet display according to any one of claims 1-3.

9. A packet data generator according to claim 8, wherein said packet pattern can be edited.

10. A packet data generator according to claim 9, wherein a packet pattern that does not exist in said logic pattern can be added to said packet pattern.

11. A packet display according to any one of claims 1 to 3, wherein said packet display unit displays the existence position of said packet in said logic pattern.

12. A packet display method for extracting packet from logic pattern having the packet and displays, the packet consisting of predetermined characters and defining an operation of a device, comprising:
a packet detection step for detecting an existence display character pattern showing the existence of said packet;
a packet start position calculation step for calculating a start position of said packet located at a predetermined distance from said existence display character pattern;
a packet data fetch step for fetching a packet data having a predetermined length from the start position of said packet;
a packet type determination step for determining the type of packet based on the fetched packet data;
a packet information calculation step for calculating a packet information corresponding to said type of packet from said packet type and said packet data; and
a packet display step for displaying said packet type and said packet information.

13. A packet display method for extracting packet from logic pattern having the packet and displays, the packet consisting of predetermined characters and defining an operation of a device, comprising:
a packet detection step for detecting an existence display character pattern showing the existence of said packet;
a packet data fetch step for fetching a packet data having a predetermined length from said existence display character pattern;
a packet type determination step for determining the type of packet based on the fetched packet data;
a packet information calculation step for calculating a packet information corresponding to said type of packet from said packet type and said packet data; and
a packet display step for displaying said packet type and said packet information.

14. A packet display method for extracting packet from logic pattern having the packet and displays, the packet consisting of predetermined characters and defining an operation of device, comprising:
a packet start position calculation step for calculating a start position of said packet;
a packet data fetch step for fetching a packet data having a predetermined length from the start position of said packet;
a packet information calculation step for calculating a packet information corresponding to said type of packet from said packet data; and
a packet display step for displaying said packet type and said packet information.

15. A packet data generation method for generating packet data from packet pattern having a packet type defining an operation of a device and a packet information corresponding to said packet type, said packet data being applied to said device, comprising:
a packet type acquisition step for acquiring the type of said packet from said packet pattern; and
a packet data calculation step for calculating a packet data from said packet information based on said packet type.

16. A computer-readable medium having a program of instructions for execution by the computer to perform a packet display processing for extracting packet from logic pattern having the packet and displays, the packet consisting of predetermined characters and defining an operation of a device, said packet display processing comprising:
a packet detection processing for detecting an existence display character pattern showing the existence of said packet;
a packet start position calculation processing for calculating a start position of said packet located at a predetermined distance from said existence display character pattern;
a packet data fetch processing for fetching a packet data having a predetermined length from the start position of said packet;
a packet type determination processing for determining the type of packet based on the fetched packet data;
a packet information calculation processing for calculating a packet information corresponding to said type of packet from said packet type and said packet data; and
a packet display processing for displaying said packet type and said packet information.

17. A computer-readable medium having a program of instructions for execution by the computer to perform a packet display processing for extracting packet from logic pattern having the packet and displays, the packet consisting of predetermined characters and defining an operation of a device, said packet display processing comprising:
a packet detection processing for detecting an existence display character pattern showing the existence of said packet;
a packet data fetch processing for fetching a packet data having a predetermined length from said existence display character pattern;
a packet type determination processing for determining the type of packet based on the fetched packet data;
a packet information calculation processing for calculating a packet information corresponding to said type of packet from said packet type and said packet data; and
a packet display processing for displaying said packet type and said packet information.

18. A computer-readable medium having a program of instructions for execution by the computer to perform a packet display processing for extracting packet from logic pattern having the packet and displays, the packet consisting of predetermined characters and defining an operation of device, said packet display processing comprising:
a packet start position calculation processing for calculating a start position of said packet;
a packet data fetch processing for fetching a packet data having a predetermined length from the start position of said packet;
a packet information calculation processing for calculating a packet information corresponding to said type of packet from said packet data; and
a packet display processing for displaying said packet type and said packet information.

19. A computer-readable medium having a program of instructions for execution by the computer to perform a packet data generation processing for generating packet data from packet pattern having a packet type defining an operation of a device and a packet information corresponding to said packet type, said packet data being applied to said device, said packet data generation processing comprising:
a packet type acquisition processing for acquiring the type of said packet from said packet pattern; and
a packet data calculation processing for calculating a packet data from said packet information based on said packet type.

20. A packet display which extracts packet from logic pattern having the packet and displays, the packet consisting of predetermined characters and defining an operation of a device, comprising:
a packet detection unit for detecting an existence display character pattern showing the existence of said packet; and
a packet display unit for displaying said packet corresponding to the detected existence display character pattern.

21. A packet display method for extracting packet from logic pattern having the packet and displays, the packet consisting of predetermined characters and defining an operation of a device, comprising:
a packet detection step for detecting an existence display character pattern showing the existence of said packet; and
a packet display step for displaying said packet corresponding to the detected existence display character pattern.

22. A computer-readable medium having a program of instructions for execution by the computer to perform a packet display processing for extracting packet from logic pattern having the packet and displays, the packet consisting of predetermined characters and defining an operation of a device, said packet display processing comprising:
a packet detection processing for detecting an existence display character pattern showing the existence of said packet; and
a packet display processing for displaying said packet corresponding to the detected existence display character pattern.
